(19) United States
(12) Patent Application Publication
(10) Pub. No.: US 2022/0011013 A1
(43) Pub. Date: Jan. 13, 2022

(54) DISPLACEMENT INDUCTION ENVIRONMENTAL SANITIZING CONTROL SYSTEM

(71) Applicant: Carson Design and Manufacturing Inc., Golden Valley, MN (US)

(72) Inventors: Christopher Michael Carson, Dawsonville, GA (US); Bret Riemenschneider, Orono, MN (US); Mark Lee Muhlstein, Maple Grove, MN (US)

(21) Appl. No.: 17/370,212

(22) Filed: Jul. 8, 2021

Related U.S. Application Data
(60) Provisional application No. 63/049,922, filed on Jul. 9, 2020.

(51) Int. Cl. F24F 13/26; F24D 19/00; F24F 13/28; F24F 3/16; F24F 13/06; F24F 1/01

(52) U.S. Cl. CPC F24F 13/26; F24D 19/0087; F24F 13/28; F24F 2221/34; F24F 13/06; F24F 1/01; F24F 3/16

(57) ABSTRACT

In one or more embodiments, a displacement induction environmental sanitizing control system for controlling the environment in a room is provided. The system includes a housing having a supply air intake configured to receive a supply of pressurized outside air, a room air intake configured to receive air into the housing from the room, and a conditioned air outlet configured to output conditioned sanitized air into the room from the housing. The housing has an airflow path from the room air intake and the supply air intake to the conditioned air outlet. A conditioning element is configured to adjust temperature of air in the airflow path. A sanitation element is configured to sanitize air in the airflow path.

### CROSS REFERENCE PARAGRAPH

This claims priority to U.S. Provisional Application No. 63/049,922 titled “DISPLACEMENT INDUCTION ENVIRONMENTAL SANITIZING CONTROL SYSTEM” and filed Jul. 9, 2020, which is hereby fully incorporated by reference herein.

### FIELD OF THE DISCLOSURE

This disclosure relates generally to heating, ventilating, and air conditioning (HVAC) systems. More specifically, and without limitation, this disclosure is directed to HVAC systems having both induction and displacement.

### OVERVIEW OF THE DISCLOSURE

Air displacement induction conditioning systems for heating and cooling typically include one or more room based displacement induction conditioning units that are operated in conjuncture with a central air-handling unit, a water treatment chiller, and a water treatment boiler. Displacement treatment of air is facilitated by the air handler, which typically pulls air from a room and retreats the air by filtering or mixing with outside air before providing the treated air to back to the room based displacement induction conditioning unit. The room based displacement induction conditioning systems also pull air from the rooms and recirculates room return air with the pressurized conditioned supply air provided by the air handling unit pulling fresh outside air in. The room based displacement induction conditioning units are unique due to being placed within the zone air directly adjacent from the room occupants thus treating and conditioning the air as close as possible with a high level of fresh clean air. The induction displacement process also delivers the air at a very low velocity, which yields a low noise level into the room thus making the air comfortable and quiet for the occupants.

It is increasingly becoming important for HVAC systems to implement measures to maintain acceptable air quality within buildings. This is particularly true in view of the global COVID-19 pandemic. Most systems utilize filtration to filter particles from air that is conditioned by the system. However, most air filtration systems are generally not capable of filtering many viruses and biological contaminants, which are particularly a concern in larger public buildings. While HEPA filters may effectively filter such viruses and biological contaminants, HEPA filters have very low airflow and require high pressure HVAC systems to filter air at a sufficient rate, not to mention being prohibitively expensive. Many existing HVAC systems are simply not capable of operating with HEPA filtration without expensive upgrades and maintenance. Even with such upgrades, HEPA filtration places great strain on and reduce operative lifetime of HVAC systems.

Some HVAC systems sanitize air by generating ozone gas using silent corona discharge or ultraviolet radiation to split Oxygen (O₂) molecules so the single atoms may attach to other O₂ molecules to form Ozone (O₃). Generated ozone gas may bind to contaminants to aid with sanitization of air. However, ozone can be harmful to humans at concentrations required for sanitation.

One or more disclosed systems sanitize air using ultraviolet (UV) irradiation and/or ionization within displacement induction conditioning units. One or more disclosed systems utilize UV light to destroy viruses and biological contaminants. Historically, there has been concern over using UV light for sanitation because direct exposure to UV light can be harmful and also because radiation in UVA and UVB spectrums cause ozone to be generated. However, it is observed that light in portions of the UVC spectrum may be used to sanitize the air without harmful exposure to humans or generation of ozone.

UV light has previously been used in some HVAC systems to prevent growth of mold and fungus. However, use of UV for sanitation of air has been largely ineffective and impractical due to the length of time air must be exposed to UV light in order to be sanitized using UV lamps of practical size and power. Through careful observation, it has been discovered that efficiency can be improved with distributed placement of UV sanitation equipment. Typically, UV sanitization equipment is centralized at a single location such as the air handler, main supply duct, or main return duct, where all air is passed though and can be treated with a minimal amount of equipment. However, in such locations air is moved at such high speeds that UV sanitation is not effective. In one or more disclosed systems, sanitization is decentralized using UV lamps located within displacement induction conditioning units of each room. While this approach might be prohibitively expensive and bulky when using conventional high powered UV lamps, airflow rate in displacement induction conditioning units are far lower, which permits UV sanitization using smaller and less expensive UV lamps. This distributed approach is also more effective because it allows air to be treated immediately after it is removed from a room when any contaminants are in higher concentration compared to when airflows are combined in conventional HVAC systems.

One or more disclosed systems additionally or alternatively utilize ionize conditioned air by positively and/or negatively charging air molecules. Ions are attracted to and bind with oppositely charged contaminants. The binding of ions may sanitize contaminants, and/or aid in settling of contaminants suspended in air, while avoiding the drawbacks of previous sanitation systems. However, ions formed by ionization tend to last for a short period of time before the ions lose their charge and become neutralized. Accordingly, it is difficult to disperse ions to priority areas of rooms to facilitate sterilization before ions are neutralized. This task is further made challenging because convection currents may initially drive ionized air to low-priority areas of a room.

Therefore, for all the reasons stated above, and the reasons stated below, there is a need in the art for an environmental control system that improves upon current systems to sanitize the air locally in the room closer to the occupants nearest to the source where contaminants are generated thereby improving efficiency, safety and quality of air.

It is therefore an object of the disclosure to provide a displacement induction environmental sanitizing control system configured to ionize and/or perform germicidal irradiation of the air to facilitate sanitation.

Another object of the disclosure is to provide a displacement induction environmental sanitizing control system that delivers ions into to a room to facilitate sanitation.

Yet another object of the disclosure is to provide a displacement induction environmental sanitizing control system that targets sanitized conditioned air to lower surfaces in a room.

Another object of the disclosure is to provide a displacement induction environmental sanitizing control system that delivers UV germicidal irradiation into to a room to facilitate sanitation.

Yet another object of the disclosure is to provide a displacement induction environmental sanitizing control system that is high quality.

Another object of the disclosure is to provide a displacement induction environmental sanitizing control system that is strong, robust, and durable.

Yet another object of the disclosure is to provide a displacement induction environmental sanitizing control system that provides unique functionality.

Another object of the disclosure is to provide a displacement induction environmental sanitizing control system that is safe to use.

Yet another object of the disclosure is to provide a displacement induction environmental sanitizing control system that is compact in size.

Another object of the disclosure is to provide a displacement induction environmental sanitizing control system that is quiet.

Yet another object of the disclosure is to provide a displacement induction environmental sanitizing control system that is efficient.

Another object of the disclosure is to provide a displacement induction environmental sanitizing control system that is easy to install.

Yet another object of the disclosure is to provide a displacement induction environmental sanitizing control system that is inexpensive to manufacture.

Another object of the disclosure is to provide a displacement induction environmental sanitizing control system that has a long useful life.

These and other objects, features, or advantages of the disclosure will become apparent from the specification, figures, and claims.

### BRIEF DESCRIPTION OF THE DRAWINGS

FIG. 1 shows a displacement induction environment sanitizing control system, in accordance with one or more embodiments of the present disclosure.

FIG. 2 shows a front view of a displacement induction conditioning system, in accordance with one or more embodiments of the present disclosure.

FIG. 3 shows a cross section side view of the displacement induction conditioning system shown in FIG. 2, in accordance with one or more embodiments of the present disclosure.

FIG. 4 shows a cross section side view of the displacement induction conditioning system shown in FIG. 2, in accordance with one or more embodiments of the present disclosure; the view showing the displacement induction conditioning system operating in a front heating mode.

FIG. 5 shows a cross section side view of the displacement induction conditioning system shown in FIG. 2, in accordance with one or more embodiments of the present disclosure; the view showing the displacement induction conditioning system operating in a cooling mode.

FIG. 6 shows a cross section side view of the displacement induction conditioning system shown in FIG. 2, in accordance with one or more embodiments of the present disclosure; the view showing the displacement induction conditioning system operating in a ventilation mode.

FIG. 7 shows a cross section side view of the displacement induction conditioning system shown in FIG. 2, in accordance with one or more embodiments of the present disclosure; the view showing air currents created in the room by the displacement induction conditioning system in operation.

FIG. 8 shows a side view of a room having a displacement induction conditioning system, in accordance with one or more embodiments of the present disclosure; the view showing air currents created in the room by the displacement induction conditioning system in operation; the view showing the plume effect that is created when conditioned sanitized air encounters an occupant in the room.

FIG. 9 is a schematic of a building having a displacement induction control systems, in accordance with one or more embodiments.

FIG. 10 shows an upper front right perspective view of a displacement induction conditioning system having a rear heating airflow path, in accordance with one or more embodiments of the present disclosure.

FIG. 11 shows a front view of the displacement induction conditioning system shown in FIG. 10, in accordance with one or more embodiments of the present disclosure.

FIG. 12 shows a cross section side view of the displacement induction conditioning system shown in FIG. 10, in accordance with one or more embodiments of the present disclosure; the view showing the displacement induction conditioning system operating in a front heating mode.

FIG. 13 shows a cross section side view of the displacement induction conditioning system shown in FIG. 10, in accordance with one or more embodiments of the present disclosure; the view showing the displacement induction conditioning system operating in a cooling mode.

FIG. 14 shows a cross section side view of the displacement induction conditioning system shown in FIG. 10, in accordance with one or more embodiments of the present disclosure; the view showing the displacement induction conditioning system operating in a ventilation mode.

FIG. 15 shows a front view of the displacement induction conditioning system shown in FIG. 14, in accordance with one or more embodiments of the present disclosure.

FIG. 16 shows a cross section side view of the displacement induction conditioning system shown in FIG. 14, in accordance with one or more embodiments of the present disclosure; the view showing the displacement induction conditioning system operating in a rear heating mode and ventilation mode.

FIG. 17 shows an upper front right perspective view of a displacement induction conditioning system having a rear heating airflow path, in accordance with one or more embodiments of the present disclosure.

FIG. 18 shows a front view of the displacement induction conditioning system shown in FIG. 17, in accordance with one or more embodiments of the present disclosure.

FIG. 19 shows a cross section side view of the displacement induction conditioning system shown in FIG. 17, in accordance with one or more embodiments of the present disclosure; the view showing the displacement induction conditioning system operating in a rear heating mode and ventilation mode.

### SUMMARY OF THE DISCLOSURE

In some various disclosed arrangements, displacement induction environmental sanitizing control systems are provided. In one or more arrangements, the displacement induction environmental sanitizing control systems are configured to operate at a low noise level without operational fans using displacement with induction. Such low noise displacement induction environmental sanitizing control systems are thought to be particularly applicable for use in buildings with HVAC systems having both induction and displacement, where the system hereof has particular utility in serving educational facilities such as classrooms, offices, patient rooms, and dorm rooms, where unneeded noise can be disruptive to an effective teaching, working, and living environments. Many schools and these types of buildings currently use displacement induction units that control the proper amount of conditioned ventilation air to the space while inducing the appropriate amount of room return air to properly condition the space. The delivery method of fresh outside air through a displacement induction unit is the ideal system to add and maximize benefits of a Bi-Polar ionization and/or a UVC lighting sterilization mechanism to sanitize the air locally in the space before properly displaced air reaches the occupants. The sterilization mechanism is configured to effectively treat and sterilize the primary and secondary air within the unit before delivering it to the occupied space. This makes the displacement induction terminal unit the perfect system for continuously sanitizing the air within the space that the occupants are inhabiting.

In one or more embodiments, a displacement induction environmental sanitizing control system for controlling the environment in a room is provided. The system includes a housing having a front, a back, sides, a top end, and a bottom end. The housing includes a supply air intake in the housing. The supply air intake is configured to receive a supply of pressurized outside air. The front of the housing has an upper section and a lower section. The upper section includes a room air intake configured to receive air into the housing from the room. The lower section includes a conditioned air outlet configured to output conditioned sanitized air into the room from the housing. The housing has an airflow path from the room air intake and the supply air intake to the conditioned air outlet. The system includes a conditioning element configured to adjust temperature of air in the airflow path. The system also includes an sanitation element operatively positioned within the housing and configured to sanitize air in the airflow path to create sanitized air. The system can also be configured to include a UV germicidal irradiation element operatively positioned within the housing and configured to supply energy to break the organic molecular bonds of germs within the air in the airflow path to destroy the DNA of harmful germs, viruses, bacteria, fungi, molds and many other harmful pollutants.

### DETAILED DESCRIPTION OF THE DISCLOSURE

In the following detailed description of the embodiments, reference is made to the accompanying drawings, which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments that address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of such articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of displacement induction environmental control systems. However, the embodiments are not so limited. It is appreciated that the embodiments may be adapted for use in other applications, which may be improved by the disclosed structures, arrangements and/or methods. The system is merely shown and described as being used in in the context of displacement induction environmental control systems for ease of description and as one of countless examples.

### System 10:

With reference to the figures, a displacement induction environmental sanitizing control system 10 (or environmental control system 10 or system 10) is presented. The system 10 is formed of any suitable size, shape, and design and is configured to condition air in one or more rooms 18 of a building 16. In an arrangement shown, as one example, the system 10 includes an air handling system 12 and at least one displacement induction conditioning system 14 (or simply room conditioning system 14) among other components.

### Air Handling System 12:

Air handling system 12 is formed of any suitable size, shape, and design and is configured to remove air from one or more rooms 18 of a building 16 and provide replacement air to the one or more rooms 18. In the arrangement shown, as one example, air handling system 12 includes an air return assembly 20, an air handling unit 22, and an air supply assembly 24 among other components.

### Air Return Assembly 20:

Air return assembly 20 is formed of any suitable size, shape, and design and is configured to provide a pathway for removal of air from the one or more rooms 18. In the arrangement shown, as one example, air return assembly 20 includes ducts 30 and a blower 32 configured to transport air from vent grille 28 in an upper portion of a room 18 to the outside. However, embodiments are not so limited. Rather, air return assembly 20 may include any combination of ductwork, vents, dampeners, filters, blowers, and/or any other components used to facilitate transportation of air in HVAC systems, and in any placement and/or arrangement.

Notably, it has been tested that placement of vent grille 28 in an upper portion of a room 18 helps to remove highly contaminated air in the upper portion of the room 18 more efficiently. By removing this highly contaminated air, this helps to maintain the overall air quality and sanitation of the room 18.

### Air Handling Unit 22:

Air handling unit 22 is formed of any suitable size, shape, and design and is configured to facilitate replacement of air removed from room 18 with pressurized conditioned supply air 38 via air supply assembly 24, which may be formed of ductwork or the like. The arrangement shown, as one example, air handling unit 22 includes a primary blower 34 configured to blow replacement pressurized conditioned supply air 38 through air supply assembly 24 to displacement induction conditioning systems 14 in rooms 18 of building 16. In this example arrangement, air handling unit 22 also includes, a conditioning element(s) 36 configured to condition the pressurized conditioned supply air 38 before it is transported to rooms 18 by primary blower 34. Such conditioning may include but is not limited to, for example, building 16 wide temperature adjustment, heating, cooling, humidity adjustment, ventilation, filtration, and/or any other conditioning that may be performed in an HVAC system. Alternatively, in some arrangements, a conditioning element 36 may be omitted.

In the arrangement shown, as one example, air handling unit 22 is configured to provide up to one hundred percent fresh air from outside of the building 16 to the room 18 via air supply assembly 24. However, embodiments are not so limited. Rather, in one or more arrangement, air handling unit 22 may be configured to mix a portion of recycled air 27 of the removed air from the air return assembly 20 with fresh outside air to produce replacement pressurized conditioned supply air 38 that is transported back to room(s) 18 via air supply assembly 24. Recycling of some of the removed air may assist to reduce energy costs, for example, when outside conditions substantially differ from indoor environmental conditions (e.g., during the peak of winter and summer).

### Heat Recovery Device 26:

In some arrangements, air handling system 12 includes a heat recovery device 26 to transfer heat between air being transferred outside and fresh replacement air being brought inside. Heat recovery device 26 is formed of any suitable size, shape, and design and is configured to transfer heat between air removed from room 18 and fresh air provided to air handling unit 22. For example, in winter heat recovery device 26 may be used to transfer heat from warmer air removed from room 18 to cooler fresh air provided to air handling unit 22. Conversely, in summer heat recovery device 26 may be used to transfer heat from warmer fresh outside air provided to air handling unit 22 to cooler air removed from room 18. Additionally, or alternatively, in some arrangements heat exchanges may be configured to transfer humidity between air removed from room 18 and fresh air provided to air handling unit 22, or the like.

### Air Supply Assembly 24:

Air supply assembly 24 is formed of any suitable size, shape, and design and is configured to provide a pathway for transportation of continuous replacement pressurized conditioned supply air 38 from air handling unit 22 to one or more displacement induction conditioning systems 14 in rooms 18 of building 16. In the arrangement shown, as one example, air return assembly 20 includes ducts 30 configured to transport air from vent grille 28 in an upper portion of a room 18 to air handling unit 22. However, embodiments are not so limited. Rather, air return assembly 20 may include any combination of ductwork, vents, dampeners, filters, blowers, and/or any other components used to facilitate transportation of air in HVAC systems, and in any placement and/or arrangement. In addition, air from air return assembly 20 may be exhausted to the outside environment.

### Displacement Induction Conditioning System 14:

Displacement induction conditioning system 14 is formed of any suitable size, shape, and design and is configured to locally condition air of a room 18 (e.g., heating and/or cooling as well as ventilation) using pressurized conditioned supply air 38 (e.g., provided by air handling system 12) to induce room return air 40 from room 18, combine room return air 40 with the pressurized conditioned supply air 38, and output the combined as conditioned sanitized air 42 back to room 18. In the arrangement shown, as one example, displacement induction conditioning system 14 includes a housing 48, a temperature conditioning element 44, and an sanitization element 46, amount other components.

### Housing 48:

Housing 48 is formed of any suitable size, shape, and design and is configured to provide a supply airflow path 50, in which room return air 40 from room 18 is induced into a room air intake 52 of housing 48 when air is flowed from a supply air intake 54 of housing 48 to a conditioned air outlet 56 of housing 48 in which conditioned sanitized air 42 is supplied into room 18.

In the arrangement shown, as one example, housing 48 includes a front 62, a back 64, opposing sides 66, a top 68 and a bottom 70. The front 62 and back 64 have generally rectangular planar shapes extending between the sides 66 and between the top 68 and bottom 70.

In this example arrangement, housing 48 includes an upper plenum 80, an air induction chamber 92, and a lower duct 106. In this example arrangement, room air intake 52 is positioned in an upper section 74 of front 62 and conditioned air outlet 56 is positioned in a lower section 76 of front 62. In this example arrangement, the supply air intake 54 is located in a side 66 of the housing 48 close to the top 68. In this example arrangement, an interior of housing 48 is sectioned to provide an upper plenum 80, an air induction chamber 92, and a lower duct 106. While embodiments are primarily described with reference to housing 48 having supply air intake 54 located in the side 66 of the housing 48, and room air intake 52 and conditioned air outlet 56 located in front 62 of housing 48, embodiments are not so limited. Rather, it is contemplated that in some various arrangements, supply air intake 54, room air intake 52, and conditioned air outlet 56 may be located in any number of additional or alternative locations in housing 48. As one example, in some arrangements supply air intake 54 may additionally or alternatively be positions in the top 68 or back 64 of housing 48.

### Upper Plenum 80:

Upper plenum 80 is formed of any suitable size, shape, and design and is configured to transport the pressurized conditioned supply air 38, received from air supply assembly 24 of air handling system 12, into the air induction chamber 92. In the arrangement shown, as one example, upper plenum 80 has a front 82, back 84, top 86 and bottom 88 forming a generally rectangular shaped duct that extends between sides 66 of housing 48. In the arrangement shown, plenum 80 is configured to blow pressurized air, received from air supply assembly 24 of air handling system 12, downward into air induction chamber 92 with the use of a plurality of nozzles 90. In this example arrangement, front 82 of upper plenum 80 is slightly sloped to facilitate airflow from temperature conditioning element 44.

### Nozzles 90:

In this example arrangement, upper plenum 80 includes a plurality of nozzles 90 in the bottom 88 through which the pressurized conditioned supply air 38 received from air supply assembly 24 is blown downward through and into air induction chamber 92. Blowing the pressurized conditioned supply air 38 through nozzles 90 compresses and accelerates the flow of air as it enters air induction chamber 92. The acceleration of air causes the induction of the room return air 40 to be pulled (induced) across the face surface of the temperature conditioning element 44.

### Air Induction Chamber 92:

Air induction chamber 92 is formed of any suitable size, shape, and design and is configured to induce room return air 40 from room 18 to be induced through room air intake 52 into air induction chamber 92, by the Venturi effect, in response to the pressurized air being blown into the air induction chamber 92 from nozzles 90. In the arrangement shown, as one example, air induction chamber 92 is a generally rectangular shaped duct with a closed back 96 and sides 102 and an open front 94, through which room return air 40 is induced through room air intake 52 and pulled across the temperature conditioning element 44 into air induction chamber 92. Air induction chamber 92 extends from an upper end 98 formed by the bottom 88 of the upper plenum 80 to a lower end 100, where air induction chamber 92 connects to lower duct 106. When room 18 air is pulled into air induction chamber 92, the room 18 air mixes with the pressurized conditioned supply air 38 received from air handling system 12 within air induction chamber 92 before the newly mixed air flows into lower duct 106.

### Lower Duct 106:

Lower duct 106 is formed of any suitable size, shape, and design and is configured to transport conditioned sanitized air 42 from air induction chamber 92 to conditioned air outlet 56 positioned in lower section 76 of front 62 of housing 48. In the arrangement shown, as one example, lower duct 106 is a generally rectangular shaped duct having a top 108, a bottom 110, and sides 112 and extending from a closed back end 114 to an open front end 116. In this example arrangement, lower duct 106 includes an opening 118 in a back portion of top 108 to facilitate airflow from air induction chamber 92 into lower duct 106.

In some arrangements, lower duct 106 may optionally include includes one or more openings (not shown) in bottom 110 and/or back end 114 to facilitate transfer of some conditioned supply air 38 and/or sanitized air 42 from lower duct 106 into bottom duct 146. This may help distribute fresh and/or sanitized air when rear airflow path 140 is used in rear heating mode. Additionally or alternatively, back 96 of air induction chamber 92 may optionally include one or more openings (not shown) to facilitate transfer of some air between air induction chamber 92 and back duct 154.

### Baffles 120:

In the arrangement shown, as one example, displacement induction conditioning system 14 includes baffles 120 in lower duct 106. Baffles 120 are formed of any suitable size, shape, and design and are configured to slow the conditioned sanitized air 42 passing through displacement induction conditioning system 14. In the arrangement shown, as one example, baffles 120 are formed as a v-shaped obstruction extending between sides 112 of lower duct 106. As a result of baffles 120, airflow of conditioned sanitized air 42 in lower duct 106 is slowed, which helps to reduce noise and increase thermal comfort to occupants 130 as the conditioned sanitized air 42 is pushed out of conditioned air outlet 56 in front 62 of housing 48 of displacement induction conditioning system 14. However, embodiments are not so limited. Rather, it is contemplated that in one or more arrangements, displacement induction conditioning system 14 may be implemented using any known type of baffles 120 to slow the flow of air in lower duct 106.

### Temperature Conditioning Element 44:

Temperature conditioning element 44 is formed of any suitable size, shape, and design and is configured to heat and/or cool air as it passes through the displacement induction conditioning system 14. In the arrangement shown, as one example, temperature conditioning element 44 is positioned behind the upper section 74 of front 62 so that room return air 40 induced through room air intake 52 passes through by temperature conditioning element 44. However, embodiments are not so limited. Rather, it is contemplated that temperature conditioning element 44 may additionally or alternatively be placed in upper plenum 80, air induction chamber 92 and/or lower duct 106.

In the arrangement shown, as one example, temperature conditioning element 44 is a hydronic coil air to water heat exchanger. In this example arrangement, temperature conditioning element 44 is configured to heat passing air when hot water is circulated through a first set of water lines 124 and through temperature conditioning element 44. Conversely, temperature conditioning element 44 is configured to cool passing air when cold water is circulated through a second set of water lines 126 and through temperature conditioning element 44. Hot and cold water may be circulated through the water lines 124 and 126, for example by a central boiler and central water chilling plant located elsewhere in building 16.

While arrangements are primarily shown and described with reference to temperature conditioning element 44 as being a hydronic coil air to water heat exchanger, embodiments are not so limited. Rather, temperature conditioning element 44 may include any heating or cooling element including but not limited to, for example, Peltier thermoelectric elements, electric coils, infrared heating elements, dielectric heating elements, other liquid/air heat exchanger, and/or any other known heating and/or cooling elements.

### Modes of Operation:

In one or more arrangements, displacement induction conditioning system 14 is configured to primarily operate in three modes: heating mode, cooling mode, and ventilation mode. In each of these modes, pressurized conditioned supply air 38 from air handling system 12 is blown through air induction chamber 92 to cause room return air 40 from room 18 to be induced through room air intake 52 and across temperature conditioning element 44. In the arrangement shown, as one example, hot water is circulated through temperature conditioning element 44 to heat the room return air 40 induced through room air intake 52 when operating in heating mode. In this example arrangement, chilled water is circulated through temperature conditioning element 44 to cool the room return air 40 drawn in through room air intake 52 when operating in cooling mode. In this example arrangement, in ventilation mode, no water is circulated through temperature conditioning element 44 and no temperature adjustment is performed by the temperature conditioning element 44. However, temperature adjustments can be made by the pressurized conditioned supply air 38 from air handling system 12 is blown through air induction chamber 92 to causing the ambient room return air 40 from room 18 to be induced through room air intake 52 and mixed before entering the room air intake 52 of the displacement induction conditioning system 14.

In one or more arrangements, displacement induction conditioning system 14 is additionally configured to primarily operate in a fourth mode. In the fourth mode known as front static heating mode, pressurized conditioned supply air 38 is not provided by air handling system 12. For example, in a commercial office building or school classrooms, air handling system 12 may be configured to shut down at night to reduced ventilation costs when the building is not in use. In the fourth mode, hot water is circulated through temperature conditioning element 44 to heat surrounding air to provide natural or radiant convection heating of room 18. In the fourth mode, natural or radiant convection causes cold air from the room 18 to flow inward through the conditioned air outlet 56 and warm air to flow out from the room air intake 52 of the displacement induction conditioning system 14.

### Sanitization Element 46:

In one or more arrangements, displacement induction conditioning system 14 includes a sanitization element 46. Sanitization element 46 is formed of any suitable size, shape, and design and is configured to ionize molecules of air. In some various arrangements, sanitization element 46 may be any type of sanitization device including but not limited to for example, ionization tubes, needlepoint ionization, UV light ionization (UVA, UVB), UV germicidal irradiation (UVC), and/or any other mechanism for sanitizing of air molecules. In some various embodiments, sanitization element 46 may be configured create positive ions, negative ions, or both positive and negative ions (bipolar ionization). While embodiments are not so limited, the disclosed arrangements are primarily shown and described with reference to sanitization element 46 being formed as a bipolar ionization tube. In the arrangement shown, as one example, sanitization element 46 is positioned in upper plenum 80 of housing 48 and is connected to an electric supply by power wires 58. As pressurized conditioned supply air 38 from air supply assembly 24 passes through upper plenum 80 molecules of the air is sanitized by sanitization element 46 by formation of positive and negative ions or using UV lightwaves, which effectively treats and sanitizes the pressurized conditioned supply air 38 entering the displacement induction conditioning system 14.

In one example arrangements, the sanitization element 46 includes an ionization element placed sufficiently close to conditioned air outlet 56 so that a high concentration level of treated air will remain in the conditioned sanitized air 42 that is provided to room 18. In room 18, ions in the conditioned sanitized air 42 will be attracted to oppositely charged contaminants suspended in the air or deposited on surfaces. When the contaminated air is contacted by the ions, the contaminated air is effectively sanitized by the ions.

In another example arrangement, the sanitization element 46 includes a UV irradiating light place sufficiently close to conditioned air outlet 56 so that a high concentration level of treated air will remain in the conditioned sanitized air 42 that is provided to room 18. In room 18, the UV light treats the air molecules in the conditioned sanitized air 42 will sanitize the air passing through the conditioned air outlet 56. When the contaminated air is contacted by the UV light, the contaminated air is effectively sanitized by the UV rays.

### Filter 122:

In one or more arrangements, displacement induction conditioning system 14 includes one or more filters 122 (not shown) for filtering air entering, leaving, and/or within displacement induction conditioning system 14. Filter 122 is formed of any suitable size, shape, and design and is configured to filter particles and/or contaminants of from air. For example, in some various implementations, filter 122 may be formed using, for example, fiber glass filters polyester and pleated filters, HEPA filters, washable air filters, activated carbon filters, electrostatic air filters, and/or any other type of air filter. In some various arrangements of displacement induction conditioning system 14 that include filter 122, filter 122 may be positioned at various locations of displacement induction conditioning system 14 for filtration of air. As one example, filter 122 may be placed behind room air intake 52 to filter room air that is induced into the displacement induction conditioning system 14. Additionally, or alternatively, filter 122 may be placed at supply air intake 54 to filter particulates (e.g., pollen) from pressurized conditioned supply air 38 provided by air handling system 12. Additionally or alternatively, filter 122 may be placed at conditioned air outlet 56 of housing 48 to filter particulates from conditioned sanitized air 42 before it is output into room 18. Placement of the filter 122 downstream from the sanitized air may help to remove additional particles from the air once the sanitized air has treated the contaminated air. Filter 122 may be particularly effective in arrangement using ion sanitization due to the increase in particle size after ions have attached.

However, embodiments are not limited to placement of filter 122 in these example locations. Rather, it is contemplated that filter 122 may be placed anywhere within housing 48 of displacement induction conditioning system 14.

### In Operation—Sanitation of Air:

As an illustrative example, during operation of displacement induction environmental sanitizing control system 10, air handling system 12 removes air via air return assembly 20 from vent grille 28 in an upper position of room 18 of building 16. Air handling system 12 transports the removed air outdoors and pushes replacement fresh pressurized conditioned supply air 38 via air supply assembly 24 to the displacement induction conditioning system 14 in room 18.

The fresh pressurized conditioned supply air 38 is received by supply air intake 54 in housing 48 of displacement induction conditioning system 14. The pressurized conditioned supply air 38 flows from supply air intake 54 into upper plenum 80. While in upper plenum 80, the pressurized conditioned supply air 38 is sanitized by the sanitation element 46, which sanitizes and treats the air. This process effectively treats and sanitizes the pressurized conditioned supply air 38 entering the displacement induction conditioning system 14 before the induction process created by the Venturi effect.

The sanitized pressurized conditioned supply air 38 is pushed by pressure from air handling system 12 through nozzles 90 and into air induction chamber 92. Nozzles 90 effectively increase pressure and velocity of the sanitized pressurized conditioned supply air 38 as it is pushed into air induction chamber 92. The sanitized pressurized conditioned supply air 38 flows downward through air induction chamber 92 past room air intake 52 and which creates induction across the temperature conditioning element 44 to lower duct 106. As sanitized pressurized conditioned supply air 38 flows downward through air induction chamber 92, a pressure drop is created that induces room return air 40 from room 18 in through room air intake 52 by the Venturi effect. As the room return air 40 is drawn in through room air intake 52 it is heated or cooled by temperature conditioning element 44 (if running) before it is induced into air induction chamber 92.

In air induction chamber 92, room return air 40 mixes with the sanitized pressurized conditioned supply air 38 and is also treated and sanitized by the sanitization element 46 to create conditioned sanitized air 42. In some various arrangements, and in some various modes of operation, temperature conditioning of the air may be performed by air handling system 12, by temperature conditioning element 44 of displacement induction conditioning system 14 of a combination thereof.

The conditioned sanitized air 42 flows from the air induction chamber 92 into the lower duct 106. In lower duct 106, baffles 120 slow the conditioned sanitized air 42 and reduce noise and increase thermal comfort as the conditioned sanitized air 42 is pushed out of conditioned air outlet 56 of housing 48 of displacement induction conditioning system 14.

As an illustrative example, when displacement induction conditioning system 14 is operating in a heating mode, air handling system 12 may be configured to provide pressurized conditioned supply air 38 to displacement induction conditioning system 14 at a rate of 60-200 cubic feet per minute (cfm) at approximately 40-70° F. Hot water lines 124 may provide water at rate of approximately 0.5 to 1.5 gallons per minute (gpm) approximately to 100-180° F. to temperature conditioning element 44 to facilitate heating of room return air 40. After the conditioned room return air 40 is mixed with pressurized conditioned supply air 38, conditioned sanitized air 42 is output from conditioned air outlet 56 at approximately 180-600 cfm at approximately 68-72° F. depending on room 18 load calculations for optimal system performance. In this manner, displacement induction environmental sanitizing control system 10 efficiently heats room 18 of building 16 while sanitizing air.

As another illustrative example, when displacement induction conditioning system 14 is operating in a cooling mode, air handling system 12 may be configured to provide pressurized conditioned supply air 38 to displacement induction conditioning system 14 at a rate of 60-200 cubic feet per minute (cfm) at approximately 50-55° F. Cold water lines 126 may provide water at rate of approximately 0.5 to 1.5 gallons per minute (gpm) approximately to 40-70° F. to temperature conditioning element 44 to facilitate cooling of room return air 40. After the conditioned room return air 40 is mixed with pressurized conditioned supply air 38, conditioned sanitized air 42 is output from conditioned air outlet 56 at approximately 180-600 cfm at approximately 68-72° F. depending on room 18 load calculations for optimal system performance. In this manner, displacement induction environmental sanitizing control system 10 efficiently cools room 18 of building 16 while sanitizing air.

As yet another illustrative example, when displacement induction conditioning system 14 is operating in a ventilation mode, air handling system 12 may be configured to provide pressurized conditioned supply air 38 to displacement induction conditioning system 14 at a rate of 60-200 cubic feet per minute (cfm) at approximately 50-80° F. In this mode, neither hot or cold water from lines 124 and 126 is circulated through temperature conditioning element 44. Room return air 40 is mixed with pressurized conditioned supply air 38 in air induction chamber 92, and conditioned sanitized air 42 is output from conditioned air outlet 56 at approximately 180-600 cfm at approximately 62-72° F. In this manner, displacement induction environmental sanitizing control system 10 efficiently ventilates room 18 of building 16 while sanitizing air.

### In Operation—Targeted Distribution of Sanitized Air in the Room for Sanitization:

As previously discussed, in one or more arrangements, the sanitization element 46 is placed sufficiently close to conditioned air outlet 56 so that a high concentration of sanitized air will remain in the conditioned sanitized air 42 that is provided to room 18. In one or more arrangements, in which sanitization element 46 performs ionization, ions distributed in room 18 by the sanitized air may further sanitize contaminants suspended in the room or deposited on surfaces when contacted by ions in the conditioned sanitized air 42.

In this example arrangement, the room air intake 52 and conditioned air outlet 56 are configured to move conditioned sanitized air 42 to lower portions of room 18, where contagious occupants 130 touch surfaces and contaminants in the air settle. In this manner, the conditioned sanitized air 42 are targeted to sanitize higher priority portions of room 18 where contaminants are more likely to be present.

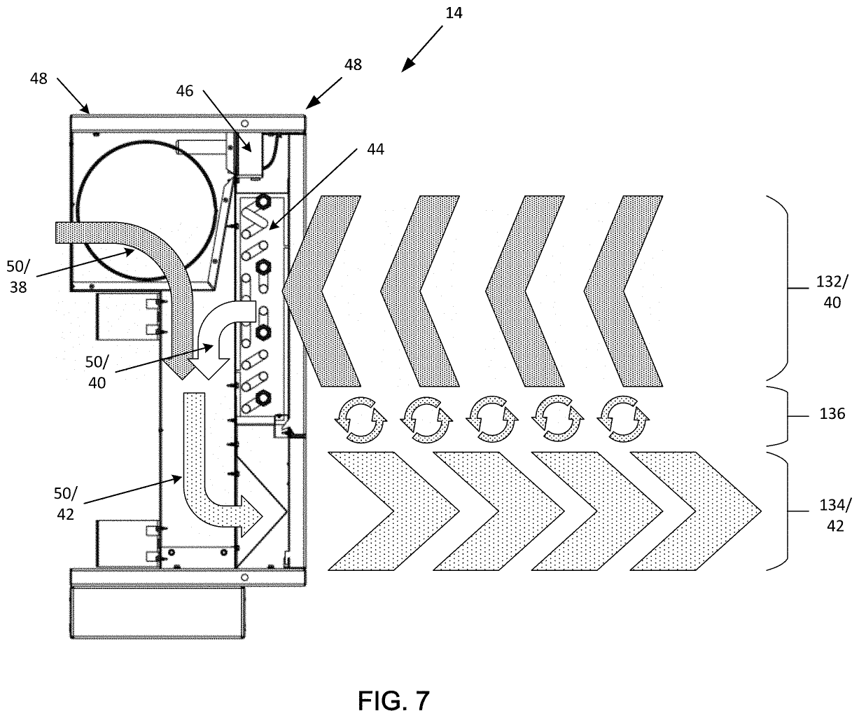

It has been surprisingly discovered that placement of room air intake 52 above conditioned air outlet 56 creates an upper air current 132 in room 18 toward room air intake 52 that help to prevent conditioned sanitized air 42 from diffusing upward (e.g., due to convection) as it travels outward from conditioned air outlet 56. As shown in FIG. 7, for example, the upper air current 132 moving toward room air intake 52, and a lower air current 134 of the conditioned sanitized air 42 moving in the opposite direction away from conditioned air outlet 56 creates a boundary layer 136 of air that inhibits upward diffusion of the conditioned sanitized air 42. In this manner, conditioned sanitized air 42 is distributed close to the floor 128 further outward into room 18 than would otherwise be possible. In this manner, the conditioned sanitized air 42 targets toward higher priority lower surfaces in room 18, where contaminants are more likely to be present due to the size of droplets exerted from the contagious occupants 130, for sanitation.

The above described mechanism for targeting higher priority lower surfaces is aided by what is sometimes referred to as the plume effect, which is created by the density differences of the conditioned sanitized air 42 and the body temperature of the occupants 130 in room 18. The plume effect refers to air currents (plume 138) that are created by the occupants 130 due to surrounding air being warmed by occupant's 130 body heat. As a result, natural or radiant convection currents around occupant 130 are created known as the plume 138.

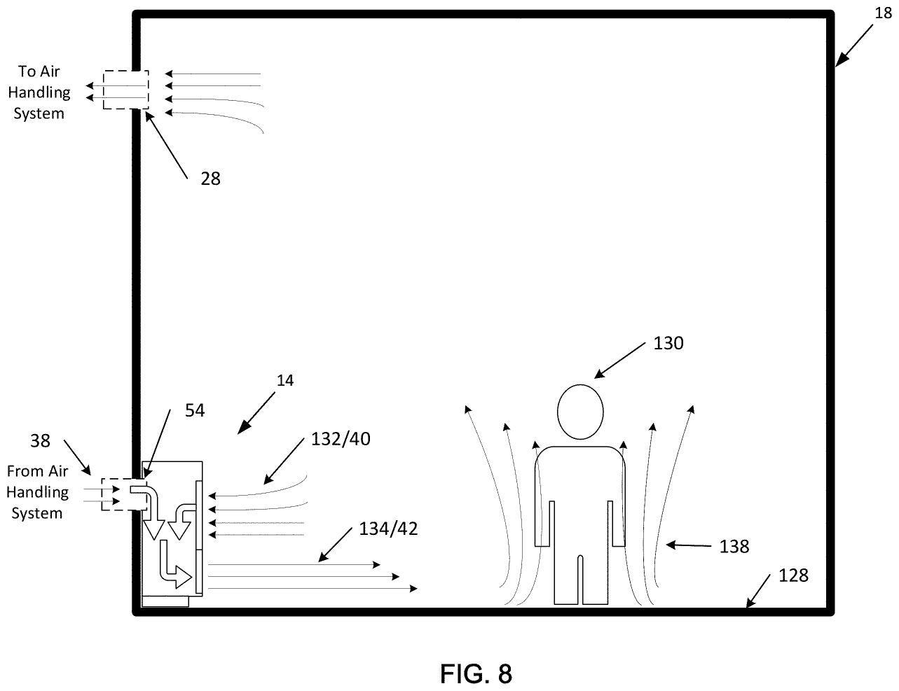

As shown in FIGS. 7 and 8, the conditioned sanitized air 42 output by displacement induction conditioning system 14 is held downward by the above described boundary layer 136 as conditioned sanitized air 42 travels outward along a floor 128 of room 18. The conditioned sanitized air 42 travels outward until an occupant 130 or heat source is encountered. When the occupant 130 is encountered, heat from the occupant 130 warms the conditioned sanitized air 42 until the inhibiting effect of the boundary layer 136 is overcome. When no longer restrained by boundary layer 136, the warmed conditioned sanitized air 42 gradually moves upward around occupant 130 via the plume effect. As a result, the conditioned sanitized air 42 is provided directly to the occupant 130 for air for breathing, sanitation of occupants 130 and/or sanitization of nearby surfaces and/or belongings.

Additionally, the plume 138 causes nearby contaminants suspended in air (e.g., resulting from a cough) to be carried upward to an upper portion of room 18, where air is removed from the room 18 by air handling system 12 via air return assembly 20 from vent grille 28. In one or more arrangements, air handling system 12 is configured to transport the removed air, having higher levels of contaminants, to the outside and replace it with fresh outside air. As a result, the pressurized conditioned supply air 38, provided to supply air intake 54 of displacement induction conditioning system 14, and the resulting conditioned sanitized air 42 output into room 18 has fewer contaminants in comparison to a traditional displacement ventilation systems, which recycle air without the induction process. Displacement induction conditioning system 14 retreats the air locally in the room 18, which creates a healthier environment for occupants 130.

Additionally, as another result of the plume effect, contaminant levels of air in lower portions of the room 18 are reduced. Accordingly, the room return air 40 induced into the room air intake 52 and combined with fresh pressurized conditioned supply air 38 from air handling system 12 has fewer initial contaminants that need to be sanitized. This process continues to treat the air in room 18 through the displacement induction conditioning system 14 causing a repeating localized sanitization of the room 18 air throughout all modes of operation.

### In Operation—Multiple Displacement Induction Conditioning Systems:

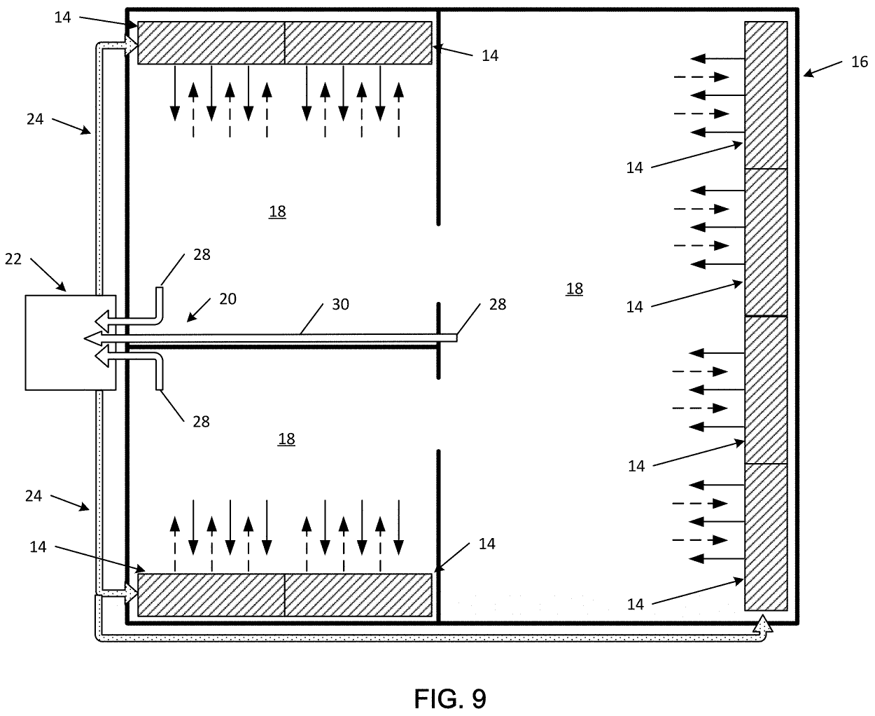

For ease of explanation, the disclosed arrangements are primarily illustrated and described with reference to a displacement induction environmental sanitizing control system 10 having an air handling system 12 and a single displacement induction conditioning system 14. However, embodiments are not so limited. Rather, in various arrangements, displacement induction environmental sanitizing control system 10 may be scaled to include any number of displacement induction conditioning systems 14 to provide environmental conditioning for any number of rooms 18 in a building 16. As an illustrative example, FIG. 9 shows a diagram of an example building 16 having three rooms 18 and a displacement induction environmental sanitizing control system 10. In this example, each room 18 includes a plurality of displacement induction conditioning systems 14 positioned along the entire length of an exterior wall for a linear distribution of conditioned sanitized air 42 provided directly to the occupant 130 within rooms 18. This type of linear distribution of conditioned sanitized air 42 provided directly to the occupant 130 within rooms 18 gives an even flow pattern of conditioned sanitized air 42.

In this example, air handling system 12 of system 10 has an air return assembly 20 with ducts 30 and vent grilles 28 to remove air from each of the rooms 18. In this example, air supply assembly 24 of air handling system 12 is configured to transport fresh pressurized conditioned supply air 38 to supply air intake 54 positioned at the first displacement induction conditioning system 14 in each room 18. In this arrangement, upper plenums 80 of the displacement induction conditioning systems 14 in each room 18 are connected in a daisy chain configuration of the air supply assembly 24 to transport the pressurized conditioned supply air 38 to each displacement induction conditioning system 14.

As previously described, the pressurized conditioned supply air 38 is sanitized by sanitization element 46 in each displacement induction conditioning system 14 to effectively treat and sanitize the pressurized conditioned supply air 38 entering the displacement induction conditioning system 14. The sanitized pressurized conditioned supply air 38 is pushed by pressure from air handling system 12 through nozzles 90 and into air induction chamber 92. As sanitized pressurized conditioned supply air 38 flows downward through air induction chamber 92, a pressure drop is created that induces room return air 40 from room 18 in through room air intake 52 by the Venturi effect. As previously described, as the room air is induced in through room air intake 52 it is heated or cooled by temperature conditioning element 44 (if running) before it is induced into air induction chamber 92. In air induction chamber 92, room 18 air mixes with the sanitized pressurized conditioned supply air 38 and is also treated and sanitized by the sanitization element 46 to create conditioned sanitized air 42, which is output back into room 18 through the conditioned air outlet 56.

In each room 18, the displacement induction conditioning systems 14 may be controlled with a respective set of valves and/or controls to adjust local environmental conditions in the room 18. Controls may permit, for example, an occupant 130 to select between modes of operation, adjust temperature levels, adjust ventilation, adjust humidity, adjust ionization levels, and/or adjust sanitization levels in the room 18. In some arrangements, the displacement induction conditioning systems 14 may be configured to operate together as one unit, for example, with all displacement induction conditioning systems 14 operating in the same mode and with the same settings. However, the embodiments are not so limited. For example, it is contemplated that, in some arrangements, displacement induction conditioning systems 14 may be configurable to have one subset of the displacement induction conditioning systems 14 operate in one mode (e.g., heating mode) and another subset of the of the displacement induction conditioning systems 14 operate in a second mode (e.g., ventilation mode). However, heating and cooling modes operating within the same zone simultaneously is prohibited by ASHRAE 90.1 standard, which would make the system operation energy inefficient. Concurrent operation of different displacement induction conditioning systems 14 in different modes may be useful, for example, to distribute sanitized air further out into the room 18 before diffusing. In some various arrangements, the subsets of the displacement induction conditioning systems 14 may be automatically controlled based on any number of different factors including but not limited to, for example, temperature, humidity levels, ionization level, particulate levels, levels of carbon monoxide or other chemicals, time of day, occupancy, energy settings, noise and/or any other quantifiable characteristic of air quality and/or user settings.

### Alternative Arrangement—Alternate Placement for Sanitization Element 46:

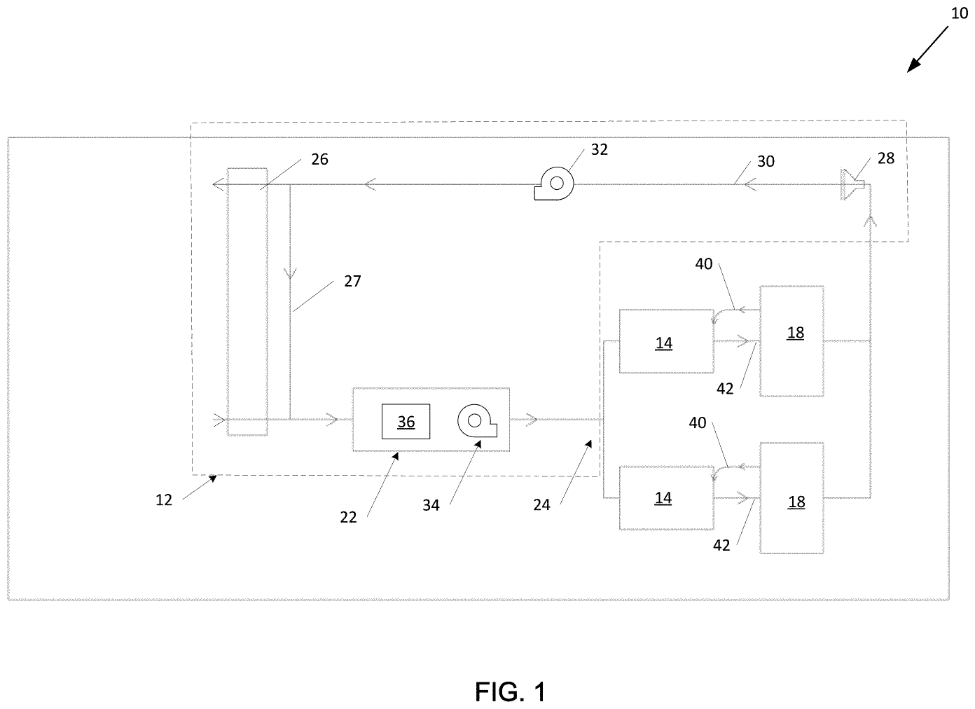

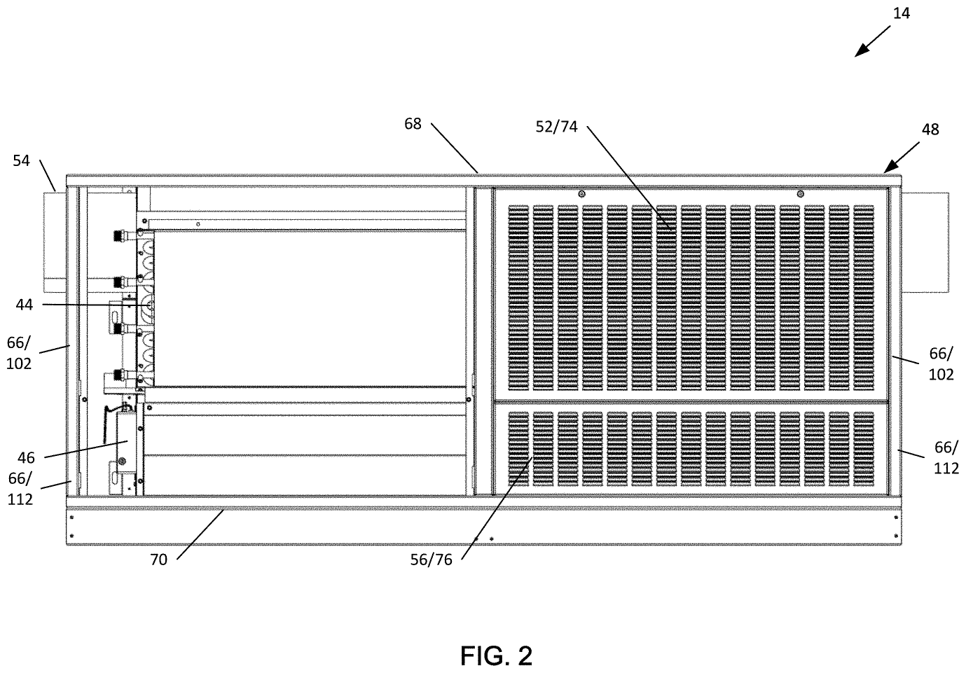

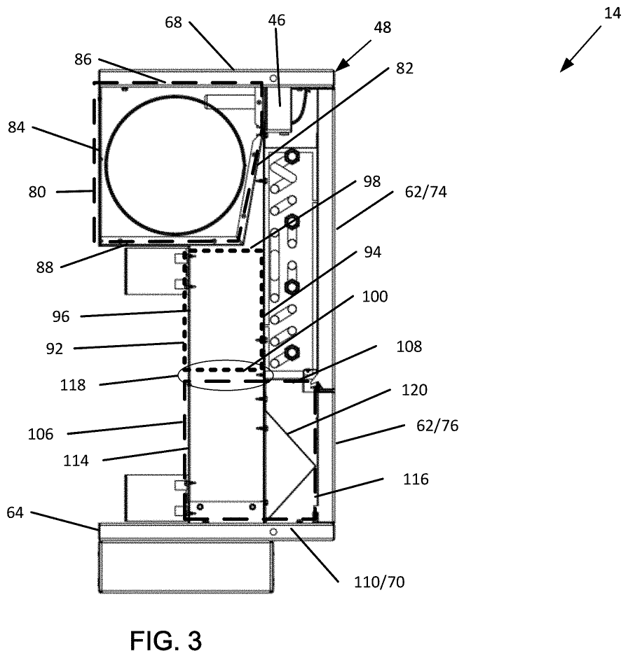

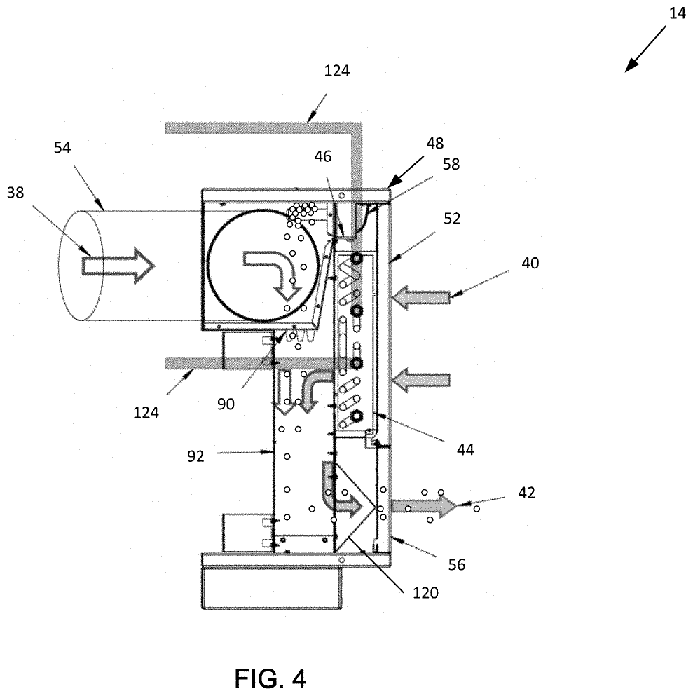

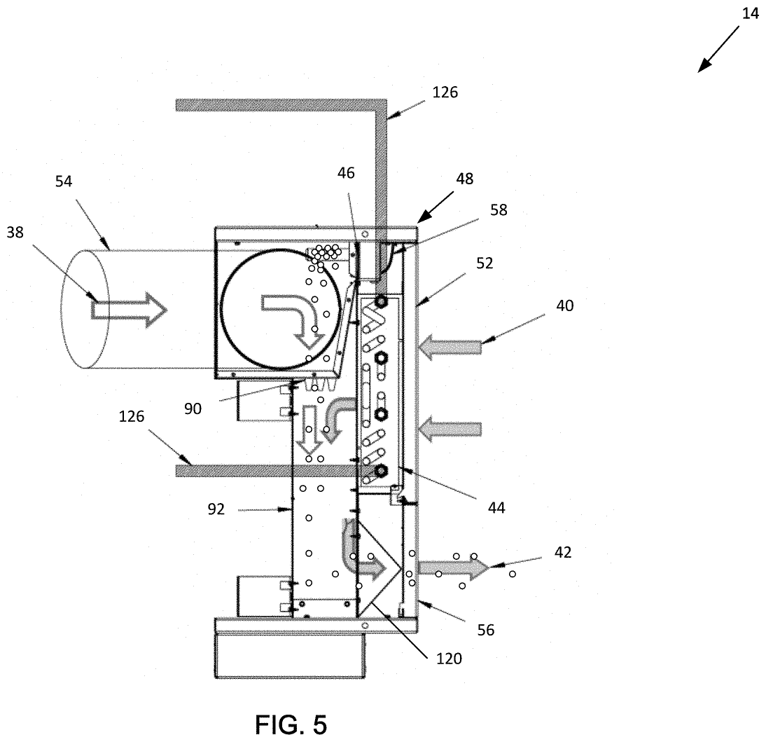

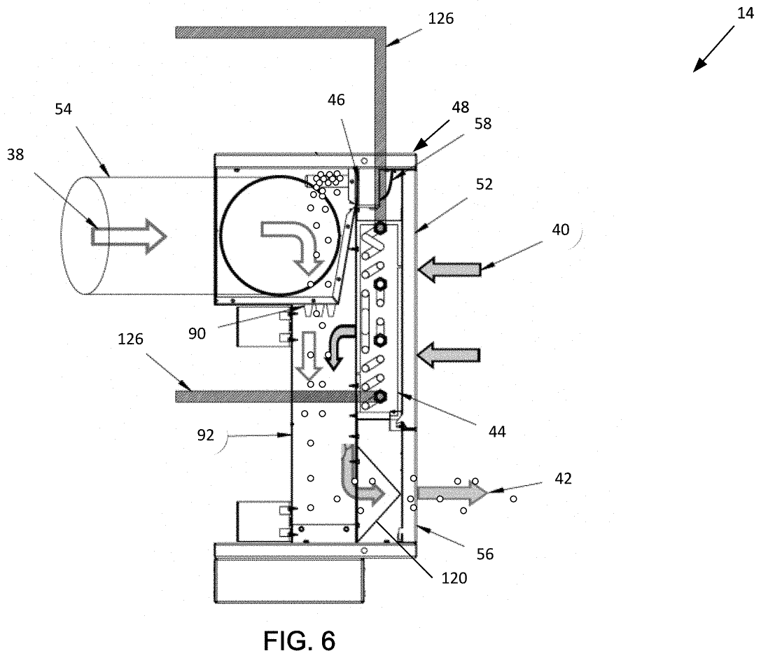

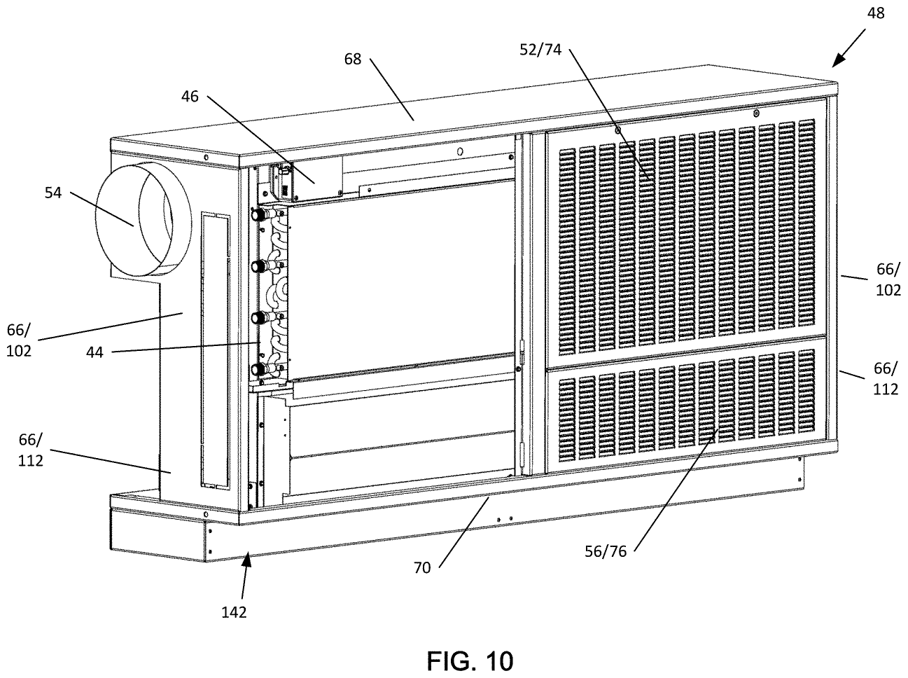

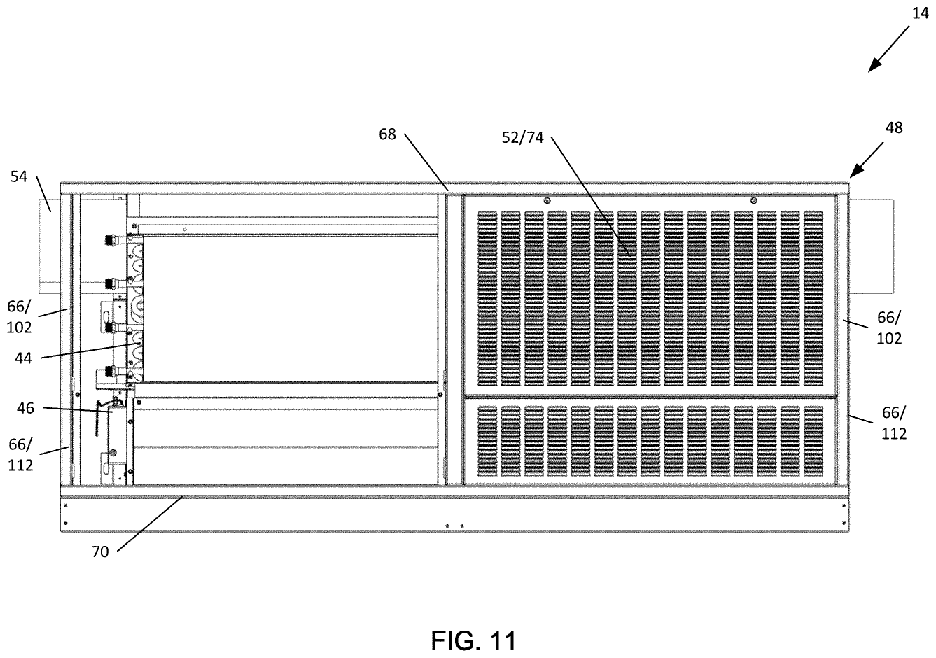

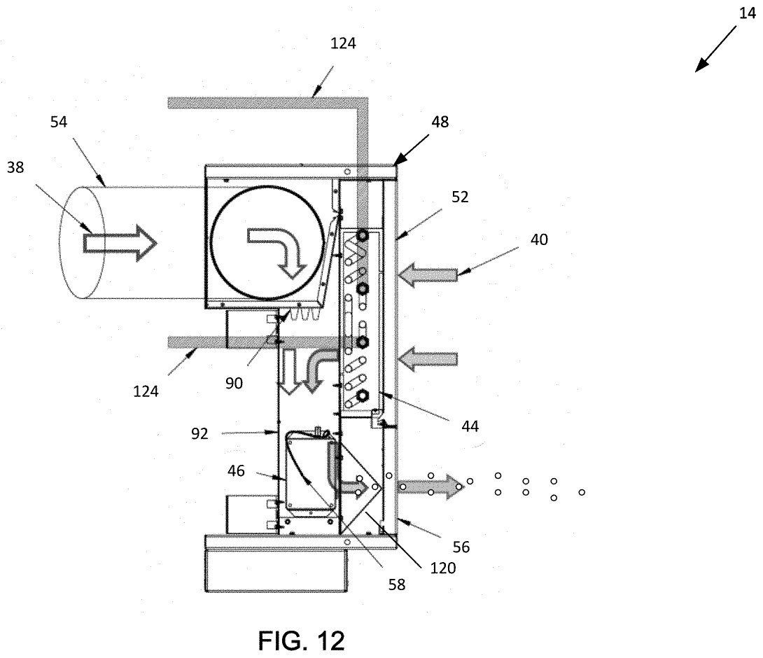

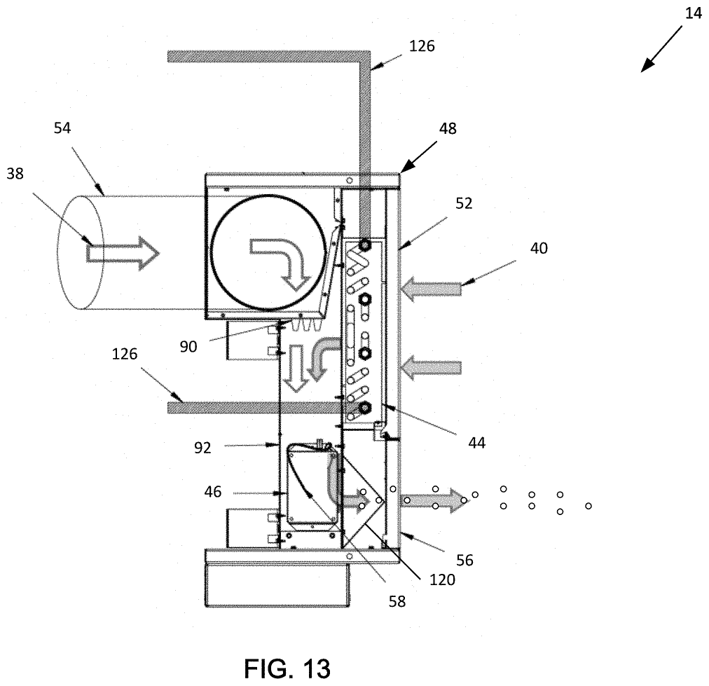

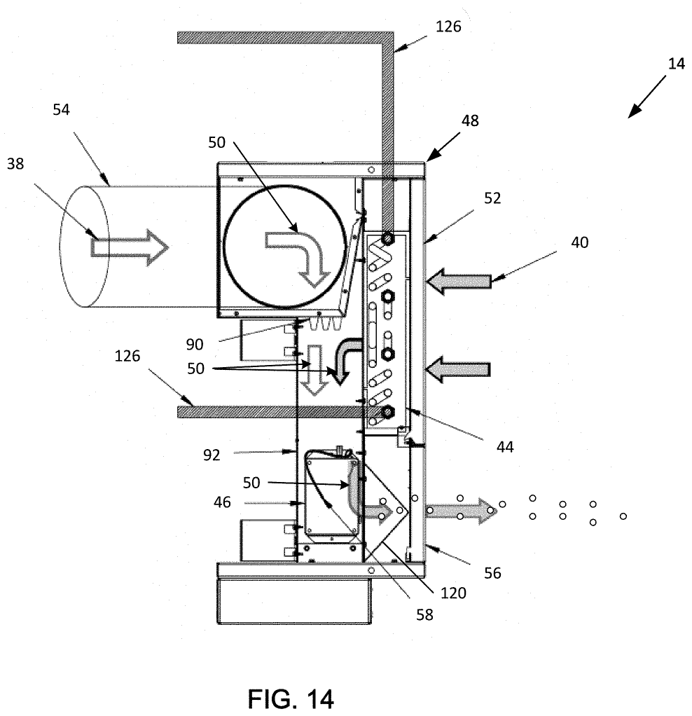

With reference to FIGS. 10-14 an alternative arrangement of a displacement induction conditioning system 14 for use in system 10 is presented. This alternative arrangement presented in FIGS. 10-14 is similar to the displacement induction conditioning system 14 presented in FIGS. 1-9 and therefore unless specifically stated otherwise herein, the prior teaching and disclosure shown in FIGS. 1-9 applies equally to the alternative arrangement shown in FIGS. 10-14. That is, the arrangement shown in FIGS. 10-14 is configured to operate in conjecture with air handling system 12 and be used with the same or similar housing 48, temperature conditioning element 44, sanitization element 46 and the like with the difference being change to position at which sanitization element 46 is located. In the arrangement shown, as one example, sanitization element 46 is positioned in the lower duct 106 of housing 48. The displacement induction conditioning system 14 shown in FIGS. 10-14 operates in a similar manner to that described with reference to FIGS. 1-9 except that sanitization element 46 sanitizes air as it enters lower duct 106 from air induction chamber 92 instead of in upper plenum 80. However, since sanitization element 46 is closer to conditioned air outlet 56, a slightly higher concentration of sanitized air should be present in conditioned sanitized air 42 output from the displacement induction conditioning system 14.

### Alternative Arrangement—Rear Airflow Path for Convection Heating:

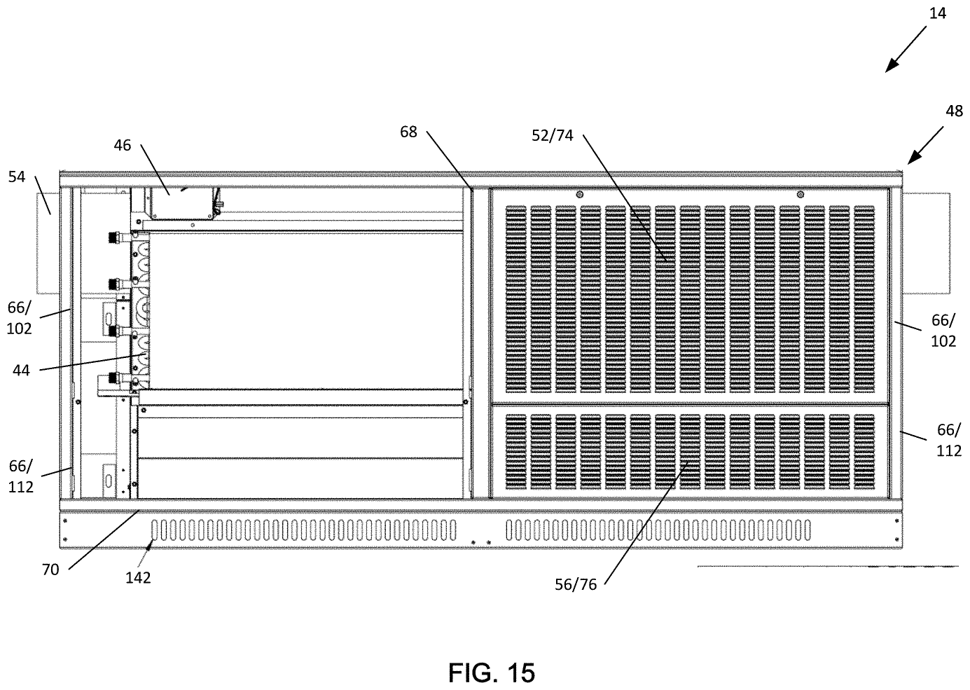

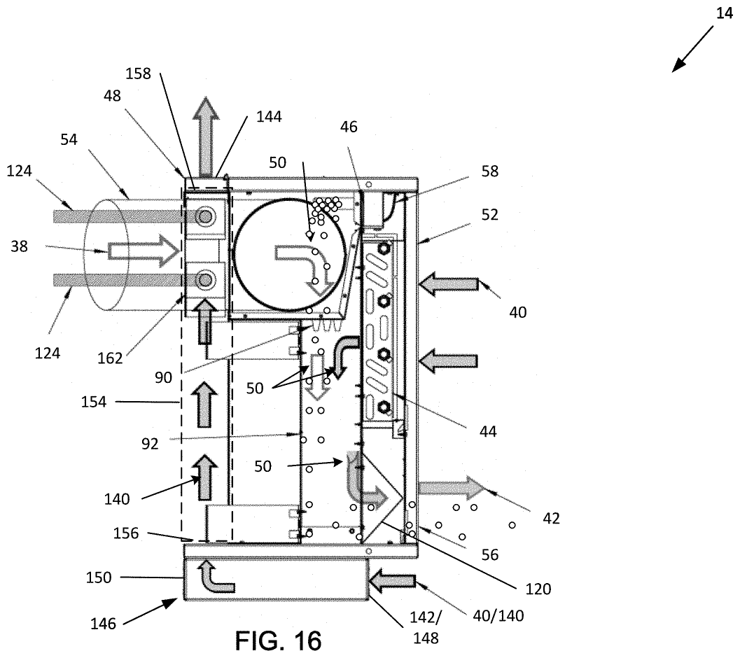

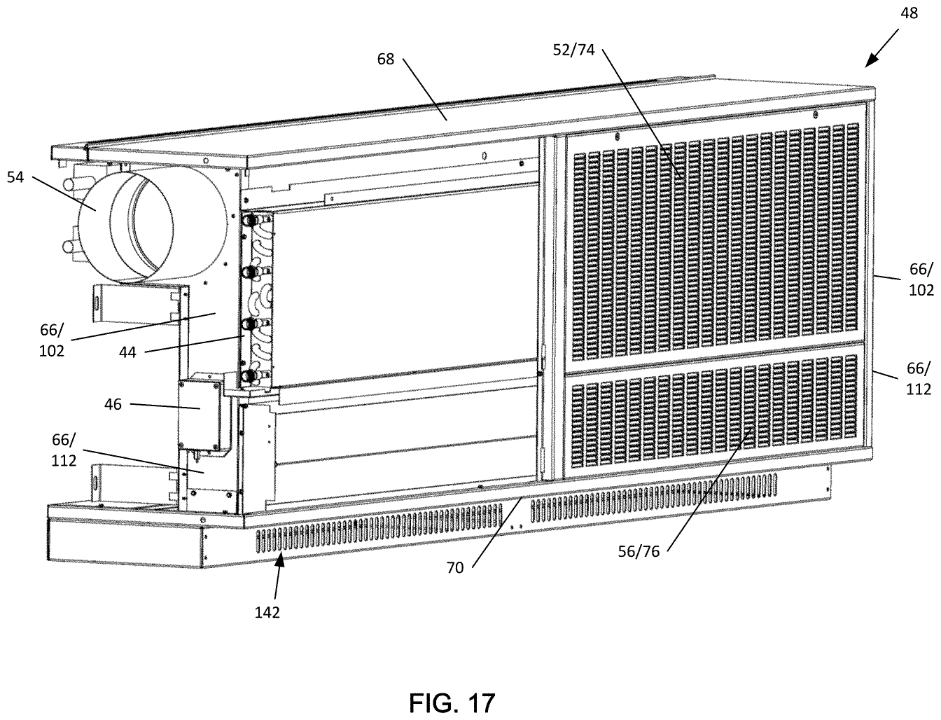

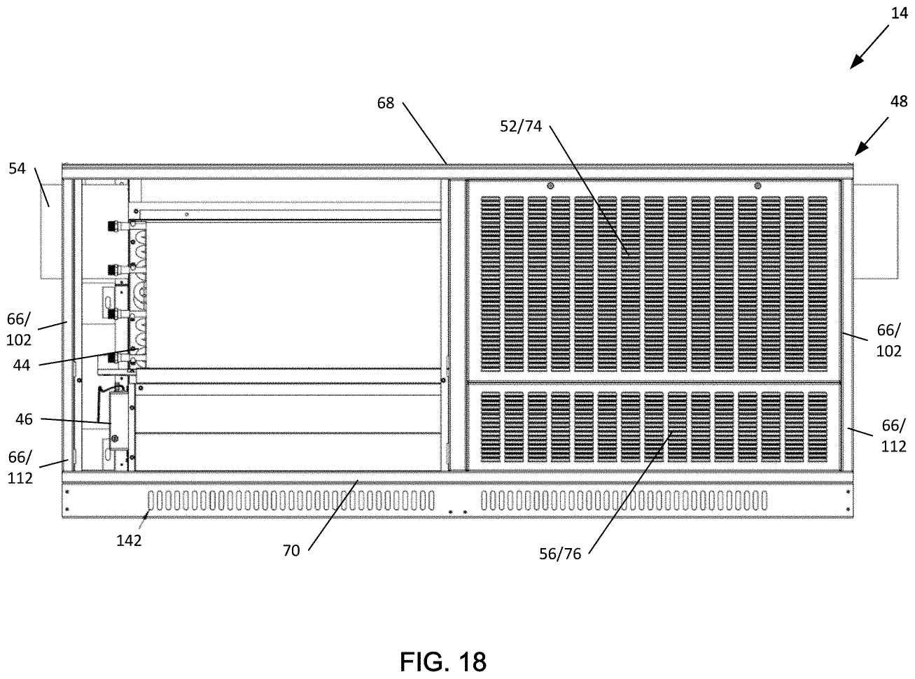

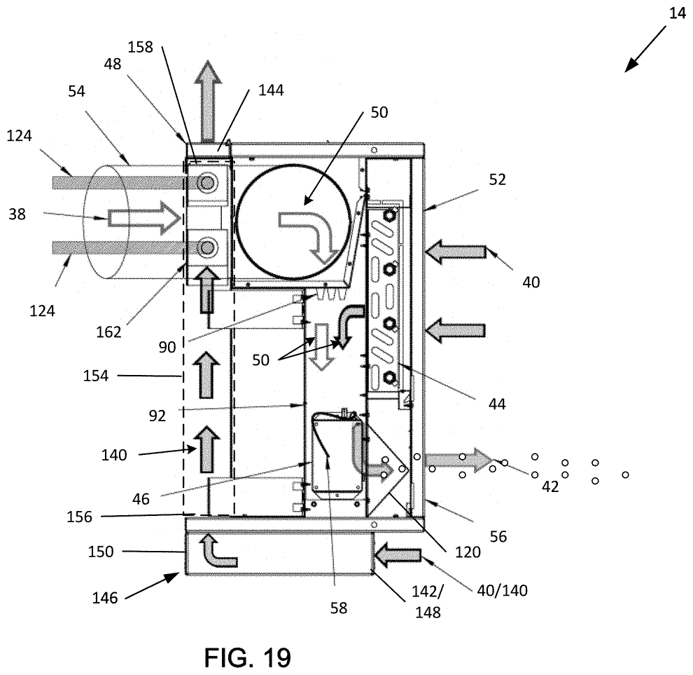

With reference to FIGS. 15-19 alternative arrangements of a displacement induction conditioning system 14 for use in displacement induction environmental sanitizing control system 10 is presented. These alternative arrangements presented in FIGS. 15-19 are similar to the displacement induction conditioning systems 14 presented in FIGS. 1-14 and therefore unless specifically stated otherwise herein, the prior teaching and disclosure shown in FIGS. 1-14 applies equally to the alternative arrangements shown in FIGS. 15-19. That is, the arrangement shown in FIGS. 15-19 is the same or similar to the arrangement shown in FIGS. 1-9, with the difference being that housing 48 is adapted to additionally provide a rear airflow path 140 for natural or radiant convection heating of room 18. Similarly, the arrangement shown in FIGS. 15-19 is the same or similar to the arrangement shown in FIGS. 10-14, with the difference being that housing 48 is adapted to additionally provide a rear airflow path 140 for natural or radiant convection heating of room 18.

### Rear Airflow Path 140:

In this alternative arrangement, rear airflow path 140 through housing 48 is formed of any suitable size, shape, and design and is configured to facilitate natural or radiant convection heating. In the arrangement shown, as one example, rear airflow path 140 is configured to facilitate a natural or radiant convection flow of air from a lower intake 142, in front 62 of housing 48 below conditioned air outlet 56, to an upper outlet 144 on top 68 of housing 48. In this example arrangement, rear airflow path 140 has an L shape with a horizontal bottom duct 146 connected to a vertical back duct 154 portion. In this example arrangement, the bottom duct 146 extends from a front end 148 at the lower intake 142 to a back end 150. In this example arrangement, the back duct 154 is positioned behind air induction chamber 92 and upper plenum 80. In this example arrangement, the back duct 154 extends from a lower end 156, connected to back end 150 of bottom duct 146, to an upper end 158 connected to upper outlet 144.

### Heating Element(s) 162:

In this alternative arrangement, displacement induction conditioning system 14 includes a heating element(s) 162. Heating element(s) 162 is formed of any suitable size, shape, and design and is configured to heat air in the rear airflow path 140. In the arrangement shown, as one example, heating element(s) 162 is positioned in the back duct 154. In this position, air heated by heating element(s) 162 flows upward and out upper outlet 144 by natural or radiant convection. However, embodiments are not so limited. Rather, it is contemplated that heating element(s) 162 additionally or alternatively be placed in the bottom duct 146.

Output of heated air from upper outlet 144 is particular advantageous when displacement induction conditioning system 14 is installed in front of large windows. In such applications, rising heated air acts as an air curtain to prevent cold air from large windows or a cold outside poorly insulated walls in winter from entering room 18.

In the arrangement shown, as one example, heating element(s) 162 is a hydronic coil air to water heat exchanger. In this example arrangement, heating element(s) 162 is configured to heat passing air when hot water is circulated through water lines 124 of the heating element(s) 162.

While arrangements are primarily shown and described with reference to heating element(s) 162 as being a hydronic coil air to water heat exchanger embodiments are not so limited. Rather, heating element(s) 162 may include any heating element(s) including but not limited to, for example, Peltier thermoelectric elements, electric coils, infrared heating elements, dielectric heating elements, other liquid/air heat exchanger, and/or any other known heating element(s) 162.

### Supply Airflow Path 50:

In this alternative arrangement, supply airflow path 50 of displacement induction conditioning system 14 includes upper plenum 80, air induction chamber 92, lower duct 106, baffles 120, temperature conditioning element 44, sanitization element 46 and/or filters 122, which operate as described with reference to FIGS. 1-14.

### Modes of Operation:

In one or more embodiments, displacement induction conditioning system 14 includes heating element(s) 162 and a temperature conditioning element 44 configurable for either heating or cooling. In this example arrangement, displacement induction conditioning system 14 is configurable to primarily operate in five modes: 1) ventilation only mode; 2) front cooling with ventilation mode; 3) front heating with ventilation mode; 4) front and rear heating with ventilation mode; and 5) rear heating with ventilation mode.

### Ventilation Only Mode:

In ventilation mode, heating element(s) 162 and temperature conditioning element 44 are both off so no temperature adjustment is performed. In this mode, the flow of fresh pressurized conditioned supply air 38 from air handling system 12 causes air to be induced in from room 18. The air from room 18 is induced and mixed with fresh pressurized conditioned supply air 38 and sanitized by sanitization element 46, as previously described with reference to FIGS. 1-14, to produced conditioned sanitized air 42 that is output from conditioned air outlet 56.

Front Cooling with Ventilation Mode:

In cooling mode, heating element(s) 162 is off and temperature conditioning element 44 is configured to cool air as described with reference to FIGS. 1-14. In this mode, air induced in from room 18 is cooled, mixed with fresh pressurized conditioned supply air 38 from air handling system 12, and sanitized by sanitization element 46, as previously described, to produced conditioned sanitized air 42 that is output from conditioned air outlet 56.

Front Heating with Ventilation Mode:

In front heating mode, heating element(s) 162 is off and temperature conditioning element 44 is configured to heat air as described with reference to FIGS. 1-14. In this mode, air induced in from room 18 is heated, mixed with fresh pressurized conditioned supply air 38 from air handling system 12, and sanitized by sanitization element 46, as previously described, to produced conditioned sanitized air 42 that is output from conditioned air outlet 56.

Front and Rear Heating with Ventilation Mode:

In front and rear heating mode, heating element(s) 162 is on and temperature conditioning element 44 is configured to heat air as described with reference to FIGS. 1-14. In this mode, air induced in from room 18 is heated, mixed with fresh pressurized conditioned supply air 38 from air handling system 12, and sanitized by sanitization element 46, as previously described, to produced conditioned sanitized air 42 that is output from conditioned air outlet 56. In this mode, air in the rear airflow path 140 is also heated by heating element(s) 162 to output natural or radiant convection heat from upper outlet 144 to condition a cold outside poorly insulated walls or windows in rooms 18.

### Rear Heating and Ventilation Mode:

In rear heating mode, heating element(s) 162 is on and the temperature conditioning element 44 is turned off. In this mode, air in the rear airflow path 140 is heated by heating element(s) 162 to output natural or radiant convection heat from upper outlet 144. In this mode, the flow of fresh pressurized conditioned supply air 38 from air handling system 12 causes room return air 40 to be induced in from room 18 in through room air intake 52. The air from room 18 is mixed with fresh pressurized conditioned supply air 38 from air handling system 12 and sanitized by sanitization element 46, as previously described, to produced sanitized air that is output from conditioned air outlet 56.

Rear heating mode is thought to be particularly useful for targeted distribution of sanitized air into room 18. In comparison to front heating mode, the conditioned sanitized air 42 is output from conditioned air outlet 56 at a cooler temperature in rear heating mode and is less subject to natural or radiant convection. As diffusion is further inhibited by boundary layer 136, sanitized air can be delivered to lower surfaces further into room 18 than would otherwise be possible allowing the plume effect to be created by room 18 occupants 130 due to surrounding air being warmed by occupants 130 body heat. As a result, natural or radiant convection currents around occupant 130 are created known as the plume 138 with reference to FIGS. 7-8.

In yet another alternative arrangement, conditioning element 44 may not be present or may be removed. In this arrangement, displacement induction environmental sanitizing control system 10 does not have its own internal heating or cooling element 44. As such, in this arrangement, displacement induction environmental sanitizing control system 10 only heats or cools room 18 from heated or cooled air provided to it through pressurized conditioned supply air 38 that enters room 18 through displacement induction environmental sanitizing control system 10. This arrangement of displacement induction environmental sanitizing control system 10 without temperature conditioning element 44 is used primarily to sanitize room 18 through the use of a sanitization element 46 as is described here. Notably, an optional rear heating (or cooling) heating element(s) 162 in a rear airflow path 140 may be present in this configuration.

From the above discussion it will be appreciated that the displacement induction environmental sanitizing control system 10 improves upon the state of the art. Specifically, in one or more arrangements, displacement induction environmental sanitizing control system 10 is provided: that have improved functionality over prior art climate control system; delivers sanitized air into to a room to facilitate sanitation; that delivers UV germicidal irradiation into to a room to facilitate sanitation; that targets sanitized conditioned air to lower surfaces in a room; that is strong, robust, and durable; that provides unique functionality; that is safe to use; that is compact in size; that is quiet; that is efficient; that is easy to install; that is inexpensive to manufacture; that has a long useful life; and/or that is high quality.

It will be appreciated by those skilled in the art that other various modifications could be made to the device without parting from the spirit and scope of this disclosure. All such modifications and changes fall within the scope of the claims and are intended to be covered thereby.

What is claimed:

1. A displacement induction environmental sanitizing control system for controlling environment in a room, comprising:
a housing, the housing having a front, a back, sides, a top end, and a bottom end;
a first intake in the housing;
wherein the first intake is configured to receive a supply of pressurized outside air;
wherein the front has an upper section and a lower section;
wherein the upper section includes a second intake configured to receive air into the housing from the room;
wherein the lower section includes a first outlet configured to output air into the room from the housing;
wherein the housing has an airflow path from the first intake and second intake to the first outlet;
a temperature conditioning element;
wherein the temperature conditioning element is configured to adjust temperature of air in the airflow path;
a sanitization element operatively positioned within the housing and configured to sanitize air in the airflow path to create sanitized air.

2. The system of claim 1, wherein airflow into the second intake above the first outlet increases a distance the sanitized air output from the first outlet will travel before rising.

3. The system of claim 1, wherein the sanitized air output from the first outlet travels along a floor of the room until the air encounters a heat source which causes the sanitized air to rise and sanitize the area around the heat source.

4. The system of claim 1, wherein the sanitization element is configured to perform ionization of the air.

5. The system of claim 1, wherein the sanitization element includes an ultraviolet light.

6. The system of claim 1, wherein the airflow path does not include a fan therein.

7. The system of claim 1, wherein airflow from the first intake to the first outlet causes air from the room to be induced into the second intake by the Venturi effect.

8. The system of claim 1, wherein the housing includes:
an upper plenum connected to the first intake,
a lower duct connected to the first outlet,
an air induction chamber positioned between the upper plenum and the lower duct;
wherein the air induction chamber has a top end connected to the upper plenum and a lower end connected to the lower duct and an open front end; and
wherein airflow from the upper plenum through the air induction chamber to the lower duct causes air from the room to be induced though the second intake and into the open front end of the air induction chamber by the Venturi effect.

9. The system of claim 1, wherein the housing includes:
an upper plenum connected to the first intake,
a lower duct connected to the first outlet,
an air induction chamber positioned between the upper plenum and the lower duct;
wherein the air induction chamber has a top end connected to the upper plenum and a lower end connected to the lower duct and an open front end; and
wherein airflow from the upper plenum through the air induction chamber to the lower duct causes air from the room to be induced though the second intake and into the open front end of the air induction chamber by the Venturi effect; and
wherein the sanitization element is positioned in the upper plenum.

10. The system of claim 1, wherein the housing includes:
an upper plenum connected to the first intake,
a lower duct connected to the first outlet,
an air induction chamber positioned between the upper plenum and the lower duct;
wherein the air induction chamber has a top end connected to the upper plenum and a lower end connected to the lower duct and an open front end; and
wherein airflow from the upper plenum through the air induction chamber to the lower duct causes air from the room to be induced though the second intake and into the open front end of the air induction chamber by the Venturi effect; and
wherein the sanitization element is positioned in the lower duct.

11. The system of claim 1, wherein the housing includes:
an upper plenum connected to the first intake,
a lower duct connected to the first outlet,
an air induction chamber positioned between the upper plenum and the lower duct;
a plurality of nozzles positioned between the upper plenum and the air induction chamber;
wherein air flows through the plurality of nozzles from the upper plenum to the air induction chamber causing air from the room to be induced though the second intake and into the air induction chamber by the Venturi effect.

12. The system of claim 1, further comprising a filter operatively connected to the housing and configured to filter air.

13. The system of claim 1, wherein the housing includes:
an upper plenum connected to the first intake;
a lower duct connected to the first outlet;
an air induction chamber positioned between the upper plenum and the lower duct; and
one or more baffles positioned in the lower duct.

14. The system of claim 1, wherein the housing includes:
an upper plenum connected to the first intake;
a lower duct connected to the first outlet;
an air induction chamber positioned between the upper plenum and the lower duct;
a plurality of nozzles positioned between the upper plenum and the air induction chamber; and
wherein the supply of pressurized outside air may be conditioned or non-conditioned outside air, wherein the supply of pressurized outside air passes from the upper plenum through the plurality of nozzles into the air induction chamber.

15. A displacement induction environmental sanitizing control system for controlling environment in a room, comprising:
a housing, the housing having a front, a back, sides, a top end, and a bottom end;
a first intake in the housing;
wherein the first intake is configured to receive a supply of pressurized outside air;
wherein the front has an upper section and a lower section.
wherein the upper section includes a second intake configured to receive air into the housing from the room;
wherein the lower section includes a first outlet configured to output air into the room from the housing;
wherein the housing has a first airflow path from the first intake and second intake to the first outlet;
an sanitization element operatively positioned within the housing and configured to sanitize air in the first airflow path to create sanitized air; and
a third intake positioned below the first outlet;
a second outlet positioned at the top end of the housing;
wherein the housing provides a second airflow path from the third intake to the second outlet; and
a heating element positioned in the second airflow path;
wherein the heating element is configured to provide natural or radiant convection heating in the second airflow path.

16. The system of 15, wherein the system is configured to concurrently output air from the first outlet and the second outlet.

17. The system of 15, wherein the air output from the first outlet is cooler than air output from the second outlet.

18. The system of 15, further comprising a temperature conditioning element in the first airflow path.

19. The system of 15, wherein the sanitization element is configured to perform ionization of air molecules.

20. The system of 15, wherein the sanitization element includes an ultraviolet light.

21. The system of 15, wherein the airflow path does not include a fan therein.

22. The system of 15, wherein airflow from the first intake to the first outlet causes air from the room to be induced into the second intake by the Venturi effect.

23. The system of 15, wherein the housing includes:
an upper plenum connected to the first intake,
a lower duct connected to the first outlet,
an air induction chamber positioned between the upper plenum and the lower duct;
wherein the air induction chamber has a top end connected to the upper plenum and a lower end connected to the lower duct and an open front end; and
wherein airflow from the upper plenum through the air induction chamber to the lower duct causes air from the room to be induced though the second intake and into the open front end of the air induction chamber by the Venturi effect.

24. The system of 15, wherein the housing includes:
an upper plenum connected to the first intake,
a lower duct connected to the first outlet,
an air induction chamber positioned between the upper plenum and the lower duct;
wherein the air induction chamber has a top end connected to the upper plenum and a lower end connected to the lower duct and an open front end; and
wherein airflow from the upper plenum through air induction chamber to the lower duct causes air from the room to be induced though the second intake and into the open front end of the air induction chamber by the Venturi effect; and
wherein the sanitization element is positioned in the lower duct.

25. The system of 15, wherein the housing includes:
an upper plenum connected to the first intake;
a lower duct connected to the first outlet;
an air induction chamber positioned between the upper plenum and the lower duct; and
one or more baffles positioned in the lower duct.

26. The system of 15, wherein the housing includes:
an upper plenum connected to the first intake,
a lower duct connected to the first outlet,
an air induction chamber positioned between the upper plenum and the lower duct;
a plurality of nozzles positioned between the upper plenum and the air induction chamber;
wherein air flows through the plurality of nozzles from the upper plenum to the air induction chamber causing air from the room to be induced though the second intake and into the air induction chamber by the Venturi effect.

27. A displacement induction environmental sanitizing control system for controlling environment in a room, comprising:
a housing, the housing having a front, a back, sides, a top end, and a bottom end;
a first intake in the housing;
wherein the first intake is configured to receive a supply of pressurized outside air;
wherein the front has an upper section and a lower section;
wherein the upper section includes a second intake configured to receive air into the housing from the room;
wherein the lower section includes a first outlet configured to output air into the room from the housing;
wherein the housing has an airflow path from the first intake and second intake to the first outlet;
a sanitization element operatively positioned within the housing and configured to sanitize air in the airflow path to create sanitized air.

28. The system of 27, further comprising a filter operatively connected to the housing and configured to filter air.

29. The system of 27, wherein the housing includes:
an upper plenum connected to the first intake,
a lower duct connected to the first outlet,
an air induction chamber positioned between the upper plenum and the lower duct;
wherein the air induction chamber has a top end connected to the upper plenum and a lower end connected to the lower duct and an open front end; and
wherein airflow from the upper plenum through air induction chamber to the lower duct causes air from the room to be induced though the second intake and into the open front end of the air induction chamber by the Venturi effect; and
wherein the sanitization element is positioned in the upper plenum.

30. The system of 27, wherein the housing includes:
an upper plenum connected to the first intake,
a lower duct connected to the first outlet,
an air induction chamber positioned between the upper plenum and the lower duct;
wherein the air induction chamber has a top end connected to the upper plenum and a lower end connected to the lower duct and an open front end; and
wherein airflow from the upper plenum through air induction chamber to the lower duct causes air from the room to be induced though the second intake and into the open front end of the air induction chamber by the Venturi effect; and
wherein the sanitization element is positioned in the lower duct.

31. The system of 27, wherein the housing includes:
an upper plenum connected to the first intake;
a lower duct connected to the first outlet;
an air induction chamber positioned between the upper plenum and the lower duct; and
one or more baffles positioned in the lower duct.

32. The system of 27, wherein the housing includes:
an upper plenum connected to the first intake,
a lower duct connected to the first outlet,
an air induction chamber positioned between the upper plenum and the lower duct;
a plurality of nozzles positioned between the upper plenum and the air induction chamber;
wherein air flows through the plurality of nozzles from the upper plenum to the air induction chamber causing air from the room to be induced though the second intake and into the air induction chamber by the Venturi effect.
